(19) United States
(12) Patent Application Publication
(10) Pub. No.: US 2022/0034345 A1
(43) Pub. Date: Feb. 3, 2022

(54) NON-PLANAR FEATURES FOR FASTENED CONNECTION

(71) Applicant: ARC ENGINEERING COMPANY LLC, Salt Lake City, UT (US)

(72) Inventor: WILLIAM CAMPBELL, Salt Lake City, UT (US)

(73) Assignee: ARC ENGINEERING COMPANY LLC, Salt Lake City, UT (US)

(21) Appl. No.: 17/388,802

(22) Filed: Jul. 29, 2021

Related U.S. Application Data
(60) Provisional application No. 63/058,449, filed on Jul. 29, 2020.

(51) Int. Cl. F16B 5/07; F16B 5/02

(52) U.S. Cl. CPC F16B 5/07; F16B 5/02

(57) ABSTRACT

Apparatuses, systems, and methods are disclosed for non-planar features for a fastened connection. A forming die is shaped to be disposed between at least two members of a fastened connection. One or more non-planar features are integrally formed from a continuous material of the forming die to at least partially deform the at least two members at an interface between the at least two members.

### CROSS-REFERENCES TO RELATED APPLICATIONS

This application claims the benefit of U.S. Provisional Patent Application No. 63/058,449 entitled “NON-PLANAR FEATURES FOR BOLTED CONNECTION” and filed on Jul. 29, 2020, for William Campbell, which is incorporated herein by reference.

### TECHNICAL FIELD

This disclosure relates to structural fastened connections and more particularly relates to non-planar features for structural fastened connections.

### BACKGROUND

Steel fabrication and steel erection are used in the construction of steel buildings, bridges, and other structural and infrastructural assets. Those that perform these services are known as steel fabricators and steel erectors. They partner closely throughout the course of a construction project and are referred to as the steel team. Fabricators are responsible for processing raw steel into the structural steel components that are ultimately assembled and installed by the erector at the site of construction. Together, steel teams work to ensure that the asset can be constructed quickly and cost-effectively.

During the construction process, structural steel components are connected and fastened in as a fastened and/or bolted connection. To create a bolted connection, fabricators fashion raw steel into the steel members, drill bolt holes in the members to accommodate fasteners, and/or provide a variety of surface preparations on the members to improve in-service strength of the connections. Erectors install these fabricated connection members on site, which entails fitting up steel pieces, often by crane, and installing and tensioning bolts in the connection. For fabricators, the cost to produce a connection may be driven by the size of the connection and the surface preparation services required. As connection size increases, so do the requirements for raw steel, hole drilling, and bolt volumes. For erectors, costs associated with connections may be driven by the complexity, size, and volume of steel members being installed. These factors may determine the difficulty of steel member fit-up during construction and the amount of bolt fastening required, which is a labor intensive, non-automated, costly process that may expose installers to hazardous conditions.

### SUMMARY

Apparatuses for non-planar features for a fastened connection are disclosed. In some embodiments, a forming die is shaped to be disposed between at least two members of a fastened connection. One or more non-planar features, in certain embodiments, are integrally formed from a continuous material of the forming die to at least partially deform the at least two members at an interface between the at least two members.

Systems for non-planar features for a fastened connection are disclosed. In one embodiment, a fastened connection includes at least two members. Through holes, in some embodiments, are disposed through the at least two members. In a further embodiment, the through holes are shaped to receive a fastener. A forming die, in certain embodiments, is disposed between the at least two members of the fastened connection. One or more non-planar features, in one embodiment, are integrally formed from a continuous material of the forming die to at least partially deform the at least two members disposed at an interface between the at least two members.

Methods for non-planar features for a fastened connection are disclosed. A method, in certain embodiments, includes disposing a forming die between at least two members of a fastened connection. In a further embodiment, a method includes at least partially deforming the at least two members at an interface between the at least two members using one or more non-planar features integrally formed from a continuous material of the forming die.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the disclosure will be described and explained with additional specificity and detail through the use of the accompanying drawings, in which:

FIG. 1 is a schematic block diagram illustrating one embodiment of a system for non-planar features for a fastened connection;

FIG. 2 is a schematic block diagram illustrating a further embodiment of a system for non-planar features for a fastened connection;

FIG. 3 is a schematic block diagram illustrating another embodiment of a system for non-planar features for a fastened connection;

FIG. 4 is a schematic block diagram illustrating a certain embodiment of a system for non-planar features for a fastened connection;

FIG. 5A is a schematic block diagram illustrating one embodiment of a forming die;

FIG. 5B is a schematic block diagram illustrating a further embodiment of a forming die;

FIG. 5C is a schematic block diagram illustrating a certain embodiment of a forming die;

FIG. 5D is a schematic block diagram illustrating another embodiment of a forming die;

FIG. 6A is a schematic block diagram illustrating one embodiment of a forming die;

FIG. 6B is a schematic block diagram illustrating a further embodiment of a forming die;

FIG. 6C is a schematic block diagram illustrating a certain embodiment of a forming die;

FIG. 6D is a schematic block diagram illustrating another embodiment of a forming die;

FIG. 7A is a schematic block diagram illustrating one embodiment of a system for non-planar features for a fastened connection;

FIG. 7B is a schematic block diagram illustrating a further embodiment of a system for non-planar features for a fastened connection;

FIG. 8A is a schematic block diagram illustrating one embodiment of a system for non-planar features for a fastened connection;

FIG. 8B is a schematic block diagram illustrating a further embodiment of a system for non-planar features for a fastened connection;

FIG. 8C is a schematic block diagram illustrating a certain embodiment of a system for non-planar features for a fastened connection;

FIG. 9 is a schematic block diagram illustrating one embodiment of a system for non-planar features for a fastened connection;

FIG. 10 is a schematic block diagram illustrating one embodiment of a method for non-planar features for a fastened connection; and

FIG. 11 is a schematic block diagram illustrating a further embodiment of a method for non-planar features for a fastened connection.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Furthermore, the described features, structures, or characteristics of the disclosure may be combined in any suitable manner in one or more embodiments. In the following description, numerous specific details are provided for a thorough understanding of embodiments of the disclosure. One skilled in the relevant art will recognize, however, that the disclosure may be practiced without one or more of the specific details, or with other methods, components, materials, and so forth. In other instances, well-known structures, materials, or operations are not shown or described in detail to avoid obscuring aspects of the disclosure.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

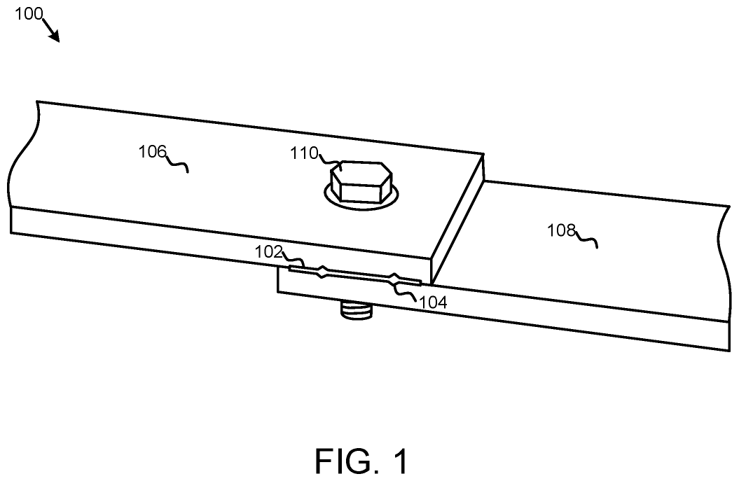

FIG. 1 depicts one embodiment of a system 100 for non-planar features 104 for a fastened connection assembly. The system 100, in the depicted embodiment, includes a forming die 102 with one or more non-planar features 104, one or more structural members 106, 108, and a fastener 110.

Fastened connections are used in many modern structural engineering applications due to their simplicity, reliability, economy, and predictable performance. In some fastened connections, load travels from one structural member 106, into a fastener 110, and into the other structural member 108 through a bearing contact interface between the fastener 110 and each of the connected structural members 106, 108. In some applications, particularly steel structures, the fastened connection may be prepared such that load is transmitted directly from one structural member 106 to another structural member 108 by friction at the interface of the structural members 106, 108. This friction may be generated by a clamping force from the installed fastener 110, which may be sufficiently tightened prior to operation. Connections that utilize this load transfer mechanism may be referred to as friction-type connections, in contrast to bearing-type connections, or the like. In fastened connections with substantial clearances between the fastener holes in the structural members 106, 108 and the fastener 110, friction-type connections are often utilized for their no-slip behavior.

Bearing-type connections may transfer load from one structural member 106, to the fastener 110, to the other structural member 108 by a bearing interaction. However, there may be at least three major failure modes for these types of connections, fastener shear, plate shear, and/or net-section failure. Fastener shear may occur in response to the load passing through the fastener 110 exceeding the capability of the fastener 110. Plate shear failure may occur due to the high stresses that occur in the plate (e.g., one or more of the structural members 106, 108) in the vicinity of the load transfer area, in response to the stresses in this region exceeding the plate's capability to retain the fastener 110. Net-section failure may occur because some or all load that is transferred through the connection passes through the cross-section of the component, which is reduced due to the presence of the fastener hole(s), failure occurring in response to the load exceeding the capacity of the reduced cross-section.

Friction-type connections may be dependent on several physical factors, such as the condition of the contacting surfaces and the total normal force between the two surfaces. In a friction-type structural connection, the contacting surfaces may be diligently prepared according to specified standard practices and the fasteners 110 in the connection may be highly tensioned prior to connection operation. A failure to obtain and/or maintain these two factors may result in a loss of friction and/or subsequent failure of the friction-type connection. Fastener 110 pretension can be difficult to obtain and verify as a plethora of factors may impact fastener 110 pretension achievement and verification. Maintaining fastener 110 pretension may be difficult as it may be lost over time due to various factors. Finally, the load transfer ability of a friction-type connection may be approximately 30-50% of an equivalently sized bearing-type connection, or the like.

In certain embodiments, a mechanical, contact-based load transfer between two structural members 106, 108 may have one or more advantages, specifically to increase the strength and/or reliability of no-slip behavior compared to a typical friction-type connection, or the like. A variety of techniques that involve the placement of a forming die 102 with one or more non-planar features 104 between contacting surfaces of structural members 106, 108 that may be embedded into the structural members 106, 108 to improve structural strength and/or provide no-slip behavior, in the presence of a fastener 110 may be used. Other joining techniques may rely exclusively or heavily on embedded elements to transfer forces between joined elements, without explicit use of a fastener 110. However, some of these techniques may enhance the strength of a no-slip connection, but do not significantly reduce the dependence on fastener 110 pretension and/or surface condition. Thus, these techniques may function to enhance the friction interaction, rather than provide differentiated, friction-independent load transfer. These limitations may also fail to increase the connection's resistance to ultimate failure.

In certain embodiments, the present disclosure may provide a technique improving a fastened connection of metallic or other members using cold-working plastic deformations in the vicinity of the fastener(s) 110 during assembly or preparation of the connection. This method may modify the stress distribution in the area of the fastener 110 when load is applied to the connection. The modified stress distribution may enhance the strength, stiffness, and/or efficiency of a fastened connection and may be independent of fastener 110 pretension, faying surface condition, and/or may not require additional restrictions on manufacturing tolerances. In contrast with other methods, this method of joining may provide improved properties that offer no-slip behavior and/or enhanced ultimate strength.

The connection technique described herein may comprise a cold-working procedure, which forms the structural members 106, 108 about a forming die 102 placed between the faying surfaces of the connected members 106, 108. This forming process may take place at a time of connection assembly and may produces contact load-transfer sites at the interface of the connected structural members 106, 108. In some embodiments, the resulting connection may have an improved connection strength and/or a higher slip-resistance capacity than a connection without a forming die 102. By improving the strength and/or slip-resistance characteristics, such a connection of equivalent capacity to a traditional connections may be achieved with a smaller footprint, without certain surface preparations, or the like. This may result in a reduction in connection material, drilling, fastener 110 counts, surface preparations, labor, or the like.

The forming die 102 and the one or more non-planar features 104 may at least partially deform the at least two structural members 106, 108 in response to a deformation load between the at least two structural members 106, 108 of the fastened connection 100 due to an applied overload. In one embodiment, the forming die 102 shaped to be disposed between at least two structural members 106, 108 of a fastened connection. For example, the forming die 102 may be substantially planar, with one or more non-planar features 104 extending from the forming die 102. In one embodiment, the forming die 102 may be disposed between at least two structural members 106, 108 and the structural members 106, 108 may be pressed against the forming die such that the one or more non-planar features 104 of the forming die 102 at least partially deform material of the at least two structural members 106, 108 (e.g., to create corresponding non-planar features 104 in the at least two structural members 106, 108, or the like).

In some embodiments, a fastener 110 may press (e.g., apply a deformation load to) the forming die 102 and one or more non-planar features 104 between the at least two structural members 106, 108 during a fastening process, and the forming die 102 may remain between the structural members 106, 108 as part of the fastened connection. In other embodiments, external pressing hardware (e.g., a clamp, a vice, a press, or the like) may press (e.g., apply a deformation load to) the at least two structural members 106, 108 (e.g., together or separately/individually) into the forming die 102 and the one or more non-planar features 104 (e.g., separately from a fastening process, prior to a fastening process, or the like) such that the forming die 102 may be removed from the at least two structural members 106, 108 and does not remain part of the fastened connection.

In embodiments where the forming die 102 remains between the structural members 106, 108 as part of the fastened connection, the forming die 102 may be disposed at one or more through holes in the at least two structural members 106, 108 which may be shaped to receive the fastener 110. The forming die 102, in one embodiment, may comprise one or more through holes shaped to receive one or more fasteners 110, such that the one or more fasteners 110 intersect the forming die 102. In other embodiments, one or more fasteners 110 may be disposed substantially adjacent to the forming die 102 (e.g., next to and/or around the forming die 102) such that the one or more fasteners 110 do not intersect the forming die 102. For example, in some embodiments, the forming die 102 may comprise a pad and/or strip with multiple non-planar features 104, surrounded by a plurality of through holes in the structural members 106, 108 and corresponding fasteners 110, or the like.

The one or more non-planar features 104, in some embodiments, are integrally formed from the same continuous material of the forming die 102, as a single continuous object. Creating a forming die 102 and one or more non-planar features 104 from the same, continuous material, in certain embodiments, provides stability for the non-planar features 104 and may ensure that the one or more non-planar features 104 are strong enough to deform a material of the structural members 106, 108, to maintain structural integrity under an applied load, or the like.

The forming die 102 and/or the one or more non-planar features 104, in one embodiment, comprise a harder material than the structural members 106, 108, so that the forming die 102 substantially maintains its shape in response to a deformation load. Substantially maintaining a shape in response to a deformation load, as used herein, means that one or more of the structural members 106, 108 is deformed by the deformation load more than the forming die 102 and/or a non-planar feature 104 is deformed by the deformation load. In various embodiments, the forming die 102 and/or a non-planar feature 104 may be at least 1.5 times as hard as a structural member 106, 108, at least 2 times as hard as a structural member 106, 108, at least 2.5 times as hard as a structural member 106, 108, at least 3 times as hard as a structural member 106, 108, at least 3.5 times as hard as a structural member 106, 108, at least 4 times as hard as a structural member 106, 108, at least 4.5 times as hard as a structural member 106, 108, at least 5 times as hard as a structural member 106, 108, or more.

In one embodiment one or more of the structural members 106, 108 comprise a metal (e.g., a ductile metal, steel, structural steel, A36 steel, aluminum, an aluminum alloy, or the like). In other embodiments, one or more of the structural members 106, 108 may comprise a wood material, a polymer material, and/or another sturdy material. The forming die 102 and/or a non-planar feature 104, in one embodiment, may comprise a metal (e.g., a hard metal, steel, alloy steel, a boron steel alloy, a chromium steel alloy, a manganese steel alloy, a molybdenum steel alloy, a nickel steel alloy, stainless steel, tool steel, and/or another hard metal), a ceramic (e.g., a structural ceramic), or the like.

In one embodiment, a non-planar feature 104 extends out of a plane of the forming die 102. In some embodiments, different non-planar features 104 on the same forming die 102 may extend in different directions (e.g., some extending up toward a first structural member 106 and others extending down toward a second structural member 108, or the like) such that a deformation load presses the non-planar features 104 into material of a structural member 106, 108 to form a corresponding non-planar feature 104 (e.g., cold press or the like). A non-planar feature 104 of a forming die 102, in a further embodiment, may comprise a negative space, a hole, an opening, or the like in the forming die 102, and a deformation load may force material of a structural member 106, 108 into the negative space, hole, opening, or the like, (e.g., cold extrusion or the like) to form corresponding non-planar features 104 in the structural member 106, 108.

A non-planar feature 104, in various embodiments, may be conical, wedge, square, rectangular, dome, pyramid, hexagon, octagon, and/or other shaped. In one embodiment, the one or more non-planar features 104 are shaped such that a load or other contact at the interface of the fastened connection creates a resultant force that is not orthogonal to an axis of the fastener 110 (e.g., due to the non-planar features 104, a force orthogonal to an axis of the fastener 110 may be diverted in a different direction (e.g., as the non-planar features 104 push the structural members 106, 108 away from each other in response to the force of the load, or the like). In this manner, in some embodiments, the one or more non-planar features 104 may transfer an external load from a first structural member 106 to a second structural member 108 at least partially through non-frictional mechanisms.

A height of a non-planar feature 104, in certain embodiments, may be selected to minimize separating deflections of the structural members 106, 108 (e.g., while still maintaining the characteristics described above). Similarly, in one embodiment, a height and/or shape of a non-planar feature 104 may be selected to minimize and/or reduce a likelihood that the non-planar feature 104 will fall, topple, tear, and/or break in response to the force of a load on the fastened connection (e.g., a wide base relative to a height of the non-planar feature 104, or the like). Non-planar features 104, in some embodiments, may be spaced and/or spread at least a predefined distance away from each other to sufficiently anchor the non-planar features 104 to the other material of the forming die 102 (e.g., the predefined distance selected based on a desired strength of the non-planar features 104, or the like).

In certain embodiments, the system 100 may comprise a waterproof seal disposed around the forming die 102 between the at least two structural members 106, 108. The waterproof seal, in various embodiments, may comprise a gasket, a washer, a lining, or the like disposed around a perimeter of the forming die 102 to prevent water or other liquids from entering between the forming die 102 and a structural member 106, 108. In a further embodiment, one or more non-planar features 104 are shaped and/or arranged to form a waterproof seal around the forming die 102 (e.g., substantially circumscribing a perimeter of the forming die 102, shaped to deform the structural members 106, 108 to form a seal, or the like).

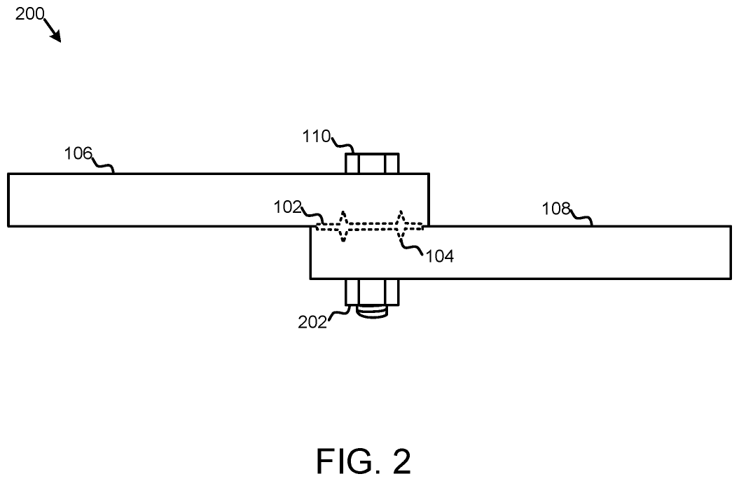

FIG. 2 depicts one embodiment of a system 200 for non-planar features 104 for a fastened connection. The system 200, in the depicted embodiment, includes a forming die 102 with one or more non-planar features 104, one or more structural members 106, 108, a bolt-type fastener 110, and a nut 202. Other embodiments may include different types of fasteners 110. The system 200, in some embodiments, may be substantially similar to the system 100 described above.

In some fastened connections, the mating surfaces of structural members 106, 108 to be joined may share a common profile. When fastened, these conforming surfaces may be brought together, and the fastener 110 may pass through a corresponding hole in each structural member 106, 108. The contacting portion of the structural members 106, 108 in immediate proximity of the fastener 110 may closely resemble a plane (e.g., a low-curvature, two-dimensional contour or the like) that is orthogonal to the axis of the fastener 110.

In certain embodiments, the system 200 comprises a planar connection geometry with a plane-like interface at a connection. Due to this geometric property of the contacting area, in some embodiments, the resultant contact force between the two structural members 106, 108 may be substantially parallel to the axis of the fastener 110. In addition, a plane-like interface may allow the resultant contact force between the two structural members 106, 108 to remain orthogonal under relative translations of the structural members 106, 108. In other words, misalignment of the fastener 110 holes in each structural member 106, 108, in certain embodiments, does not impact the direction of the contact force between the two structural members 106, 108. This property may be highly valued because it promotes robust and convenient fit-up. However, in some embodiments, this property may limit the possible load transfer mechanisms to the bearing-type and friction-type mechanisms described above.

The present disclosure describes a method to achieve, in certain embodiments, enhanced connection properties, by modifying the plane-like interface of the joined structural members 106, 108 by creating non-planar features 104 in close proximity to the fastener 110, or the like. To preserve the desirable fit-up properties, in some embodiments, the non-planar features 104 may be created at the final and/or near-final step of assembly (e.g., after fit-up). For example, subsequent to fit-up, in one embodiment, the planar interface may be modified as non-planar features 104 are introduced.

The non-planar features 104 may create an interface of the structural members 106, 108 such that normal contact of the interface creates a resultant force that is not orthogonal to the fastener 110 axis when the structural members 106, 108 are subjected to translations parallel to the undisturbed interface plane. In response to external loads being applied to this connected area, loads may be transferred directly from one structural member 106 to the other structural member 108 at the non-planar features 104 through non-frictional mechanisms.

Performing the deformation process after joint fit-up, in one embodiment, may have the added benefit of not requiring additional restrictions on manufacturing tolerances for the joined components. In fact, because of the fit-up flexibility and improved performance afforded by this technique, in some embodiments, it is possible to reduce manufacturing tolerances in many applications and still achieve enhanced performance. In one embodiment, some deviations on the sequence of feature formation may be possible and a non-planar interface may be achieved in a variety of positions, such that tight tolerancing may not be required.

To create non-planar features 104 through plastic deformation with the properties described, the following method is disclosed. In one embodiment, a forming die 102 is placed between the interface of the structural members 106, 108 to be joined, at each fastener 110 hole. After achieving fit-up, in some embodiments, an overload is applied to the structural members 106, 108 (e.g., roughly parallel to the axis of the fastener 110 hole). The forming die 102, in some embodiments, has properties such that under high deformation loads, the forming die 102 maintains a shape that promotes desirable deformation of the structural members 106, 108. This property, in some embodiments, may be achieved through material differences between the forming die 102 and the joined material, the geometry of the forming die 102, or the like. After deformation, in certain embodiments, the forming die 102 may remain between the structural members 106, 108, and the joint assembly may be completed by installing fasteners 110, 202, hardware, or the like.

One or more non-planar features 104 that are created, in some embodiments, may be shaped to react to external shear loads directly from one structural member 106 into the other structural member 108 by means of contact forces rather than friction. Many other feature geometries may provide this property, and the disclosure is not limited to the depicted or described set of features. With some feature geometries, applied shear loads to the connection may cause reactions at the non-planar features 104 that are neither parallel nor orthogonal to the axis of the fastener 110.

In other words, in certain embodiments, the reacted loads at the non-planar features 104 may have component forces both in the direction of the applied forces and perpendicular to the applied forces. For this reason, externally applied loads to the connection may encourage separation of the structural members at the location of the non-planar features 104. The deflections that occur at the non-planar features 104, which may be parallel to the fastener 110 axis, and may be the result of the separating forces described above will herein be referred to as separating deflections. In some embodiments, the magnitude of the separating deflections in the connection when subjected to shear loads may be mitigated, as excessive deflections may compromise the strength and stiffness of the connection.

To optimize the connection, in some embodiments, the separating deflections at the non-planar features 104 may be significantly small with respect to the height of the non-planar features 104. The height of the non-planar features 104 may be defined as the distance dimension of the non-planar feature 104 that is parallel to the axis of the fastener 110, or the like. The separating deflections, in certain embodiments, may be a function of separating forces and the compliance of the load path through which the separating forces are ultimately reacted by the fastener 110, or the like.

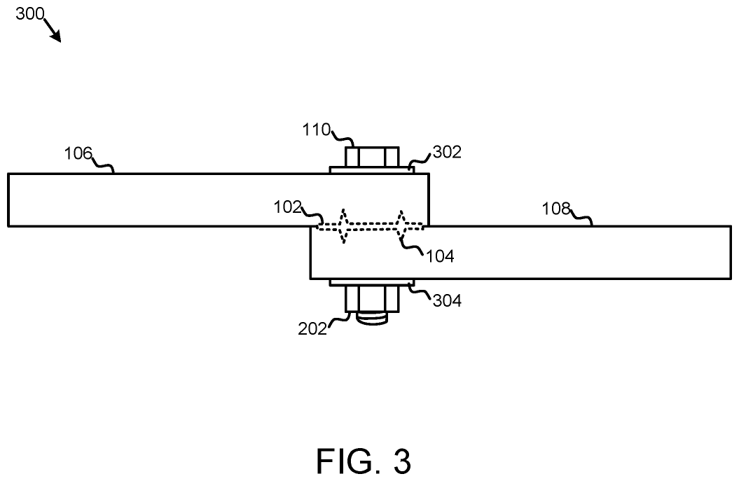

FIG. 3 depicts one embodiment of a system 300 for non-planar features 104 for a fastened connection. The system 300, in the depicted embodiment, includes a forming die 102 with one or more non-planar features 104, one or more structural members 106, 108, a bolt-type fastener 110, a nut 202, and one or more washer-type elements 302, 304. Other embodiments may include different numbers and/or types of fasteners 110, 202, washer-type elements 302, 304, or the like. The system 200, in some embodiments, may be substantially similar to the system 100 and/or the system 200 described above.

The one or more washer-type elements 302, 304 in the load path of the fastened connection, in one embodiment, increase a stiffness of the load path to minimize separating deflections between the structural members 106, 108. In certain embodiments, a sufficiently stiff load path may mitigate separating deflections while having non-planar features 104 with significantly large heights, such that the ratio of deflections to non-planar feature 104 height is sufficiently small. This ratio, in various embodiments, may be less than about 30%, less than about 25%, less than about 20%, less than about 15%, less than about 10%, less than about 5%, or the like. To achieve this ratio, in some embodiments, a stiffness of the load path may be enhanced through the addition of one or more washer-type elements 302, 304 within this load path, or the like.

In one embodiment, a secondary benefit of creating features of sufficient height to achieve the described optimized connection, may be that the performance of the connection may be largely independent of the surface condition of the joined structural members 106, 108. This may serve as an advantage over standard friction-type connections, which may be heavily dependent on the condition of the faying surface.

Separating forces, as described above, may result in tension in the fastener 110, 202. Because of this, in some embodiments, when subjected to external shear loading, a resultant tension may be developed in the fastener 110, 202. In one embodiment, this may provide an advantage over traditional no-slip, friction-type connections in that the connection's ability to react to shear loads may not be significantly dependent on fastener 110, 202 pre-tension. In some embodiments, one of the only effects of fastener 110, 202 pretension may be that it has a small contribution to the compliance of the load path, which has been demonstrated in tests to be minimal.

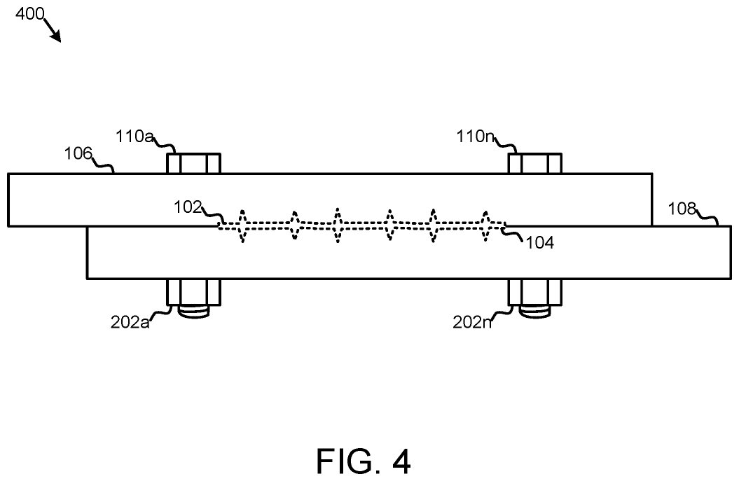

FIG. 4 depicts one embodiment of a system 400 for non-planar features 104 for a fastened connection. The system 400, in the depicted embodiment, includes a forming die 102 with one or more non-planar features 104, one or more structural members 106, 108, and two or more bolt-type fasteners 110a-n with corresponding nuts 202a-n. Other embodiments may include different numbers and/or types of fasteners 110a-n, 202a-n, or the like. The system 400, in some embodiments, may be substantially similar to the system 100, the system 200, and/or the system 300 described above.

In the depicted embodiment, the forming die 102 is disposed substantially adjacent to and between a plurality of fasteners 110a-n (e.g., two fasteners 110a-n, three fasteners 110a-n, four fasteners 110a-n, five fasteners 110a-n, six fasteners 110a-n, seven fasteners 110a-n, eight fasteners 110a-n, or more fasteners 110a-n) and corresponding through holes in the structural material 106, 108. The fasteners 110a-n, in the depicted embodiment, are adjacent to the forming die 102 but do not intersect the forming die 102 (e.g., the forming die 102 has no through holes for receiving the fasteners 110a-n). In certain embodiments, the plurality of fasteners 110a-n may exert a greater deformation force, may allow for a larger forming die 102, or the like than embodiments with a single fastener 110.

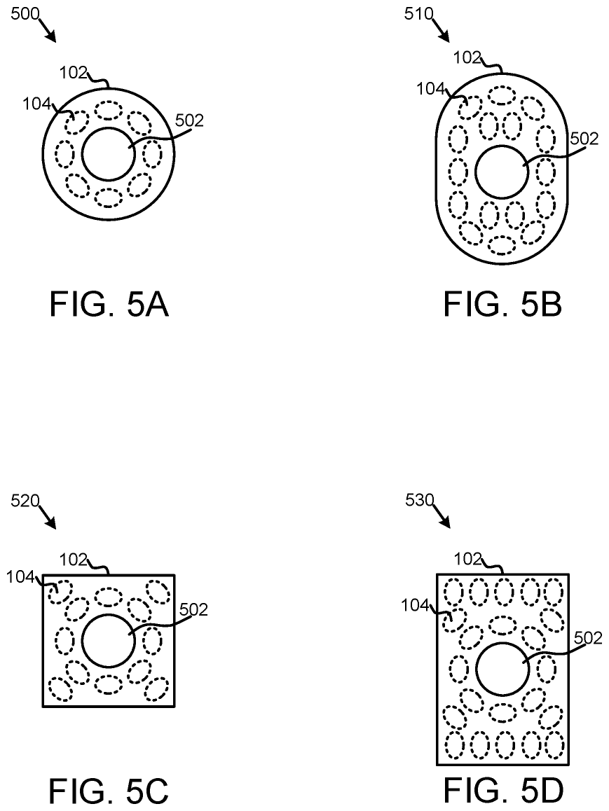

FIG. 5A depicts one embodiment 500 of a forming die 102. In the depicted embodiment 500, the forming die 102 is round and substantially circular, with a through hole 502 shaped to receive a fastener 110. The non-planar features 104 are rounded and ovals, and may alternate directions (e.g., into and out of the forming die 102, up and down, or the like).

FIG. 5B depicts a further embodiment 510 of a forming die 102. In the depicted embodiment 510, the forming die 102 is rounded and substantially an oval, with a through hole 502 shaped to receive a fastener 110. The non-planar features 104 are rounded and ovals, and may alternate directions (e.g., into and out of the forming die 102, up and down, or the like).

FIG. 5C depicts a certain embodiment 520 of a forming die 102. In the depicted embodiment 520, the forming die 102 is rectangular and substantially a square, with a through hole 502 shaped to receive a fastener 110. The non-planar features 104 are rounded and ovals, and may alternate directions (e.g., into and out of the forming die 102, up and down, or the like).

FIG. 5D depicts another embodiment 530 of a forming die 102. In the depicted embodiment 530, the forming die 102 is substantially rectangular, with a through hole 502 shaped to receive a fastener 110. The non-planar features 104 are rounded and ovals, and may alternate directions (e.g., into and out of the forming die 102, up and down, or the like).

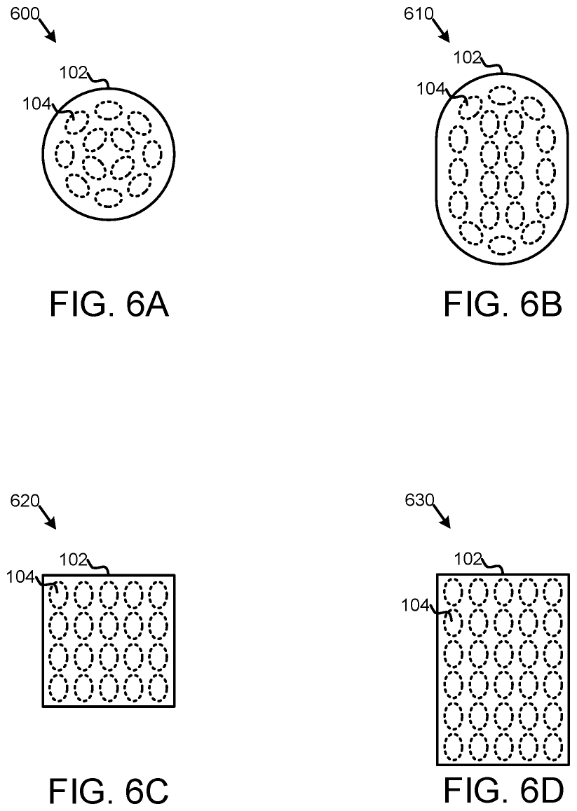

FIG. 6A depicts one embodiment 600 of a forming die 102. In the depicted embodiment 600, the forming die 102 is round and substantially circular, without a through hole 502, so that a fastener 110 will not intersect the forming die 102 but may be adjacent to the forming die 102. The non-planar features 104 are rounded and ovals, and may alternate directions (e.g., into and out of the forming die 102, up and down, or the like).

FIG. 6B depicts one embodiment 610 of a forming die 102. In the depicted embodiment 610, the forming die 102 is rounded and substantially an oval, without a through hole 502, so that a fastener 110 will not intersect the forming die 102 but may be adjacent to the forming die 102. The non-planar features 104 are rounded and ovals, and may alternate directions (e.g., into and out of the forming die 102, up and down, or the like).

FIG. 6C depicts one embodiment 620 of a forming die 102. In the depicted embodiment 620, the forming die 102 is rectangular and substantially a square, without a through hole 502, so that a fastener 110 will not intersect the forming die 102 but may be adjacent to the forming die 102. The non-planar features 104 are rounded and ovals, and may alternate directions (e.g., into and out of the forming die 102, up and down, or the like).

FIG. 6D depicts one embodiment 630 of a forming die 102. In the depicted embodiment 630, the forming die 102 is substantially rectangular, without a through hole 502, so that a fastener 110 will not intersect the forming die 102 but may be adjacent to the forming die 102. The non-planar features 104 are rounded and ovals, and may alternate directions (e.g., into and out of the forming die 102, up and down, or the like).

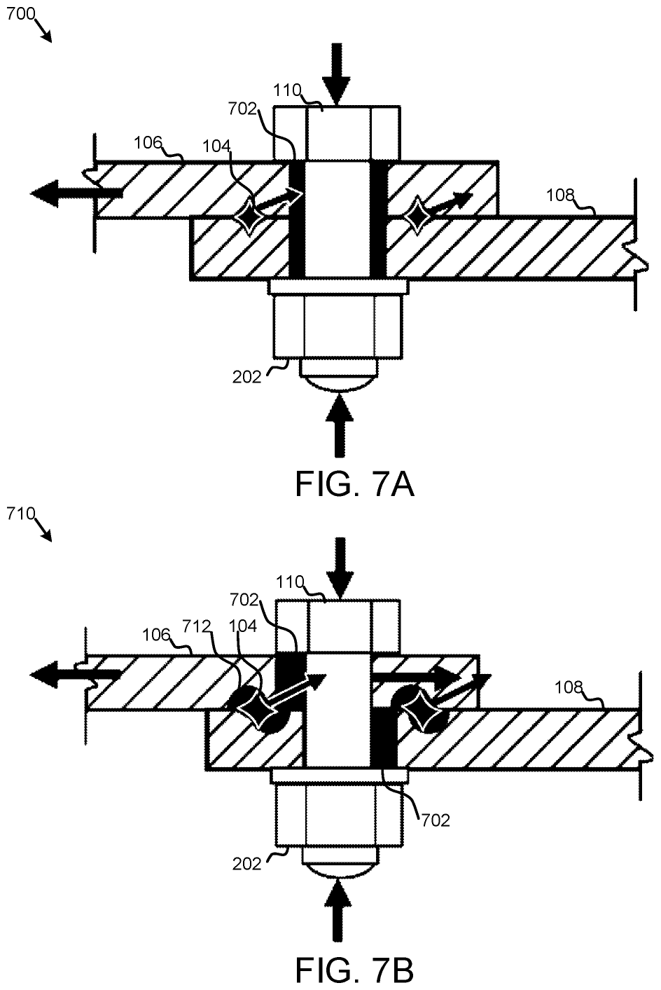

FIG. 7A depicts one embodiment of a system 700 for non-planar features 104 for a fastened connection. Other bolted connections for structural steel may fall into two categories, such as bearing and slip-critical, or the like. These two connection types may be differentiated by the distinct mechanisms by which loads are transferred between the connected members 106, 108. Bearing connections may transfer loads from one structural member 106 to another structural member 108 via contact of the bolt hole 502 in the member 106, 108 with the bolt 110. Bearing-type connections may fail due to failure of the bolt 110 or failure of the plate material of the member 106, 108 where the bolt 110 is in contact.

Slip-critical connections may transfer loads from one structural member 106 to another structural member 108 via the friction that exists at the faying surfaces of the two connected members 106, 108 subjected to clamping forces from tensioned fasteners 110. When applied loads exceed the capacity of the friction, the connection may slip. Once slip has occurred, the connection may behave as a bearing connection.

In the depicted embodiment, the one or more non-planar features 104 transfer loads in a different manner than other bolted connections. When a connection 700 is initially loaded in its service application, load may transfer directly from one structural member 106 to another structural member 108 through the non-planar features 104 produced at the cold-worked sites of the interface. During this phase of initial loading, tension may be developed in the fastener 110 as constraint is provided to the interface while the shear loads through the fasteners 110 may be substantially zero. As an applied load increases, material yielding may initiate at the cold-worked site and the rate of connection displacement may increase.

FIG. 7B depicts a further embodiment of a system 710 for non-planar features 104 for a fastened connection. As described above with regard to FIG. 7A, when a connection is initially loaded in its service application, load may transfer directly from one member 106 to another member 108 through the non-planar features 104, or the like, and tension may develop until material yielding and displacement of the connection exceeds the clearance of the fastener 110 in the bolt hole 502 and the bolt 110 transitions into bearing the load, or the like.

At this point, in certain embodiments, the connection stiffness may increase in response to an elastic load transfer of the bolt 110 bearing. As loads increase further, the bolt 110 may begin to yield and eventually fail. The non-planar features 104 may divert at least a portion of the load out of a plane of the structural members 106, 108, in a direction that is not orthogonal to the fastener 110, extending the life of the connection, delaying failure of the bolt 110, increasing the load which the connection may bear, or the like.

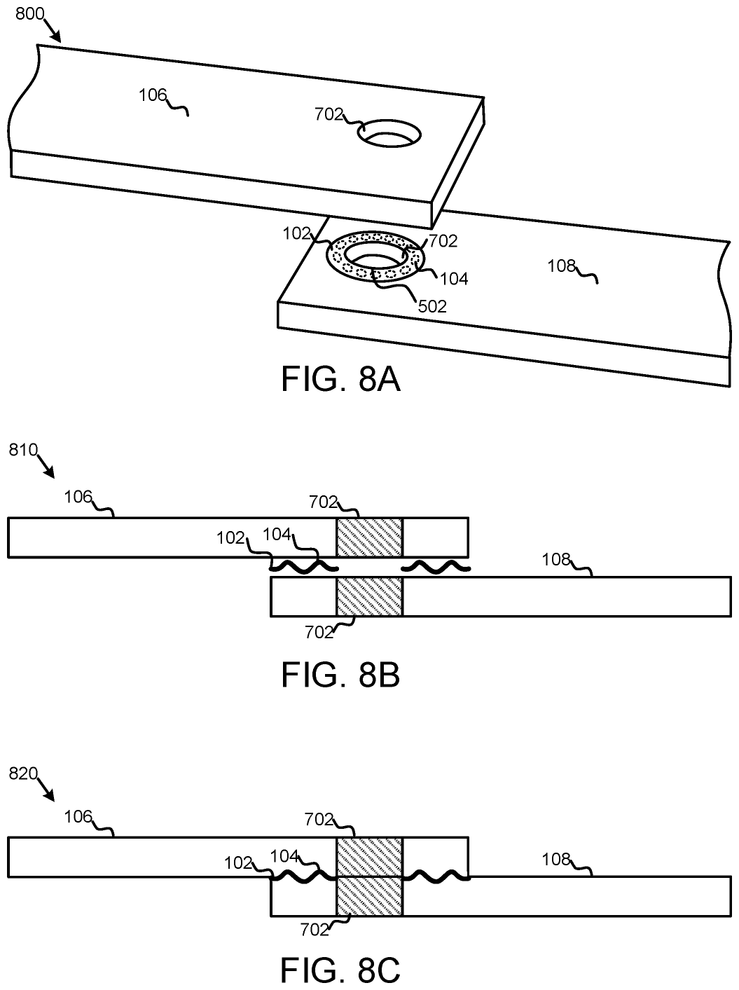

FIG. 8A depicts one embodiment of a system 800 for non-planar features 104 for a fastened connection. In the depicted embodiment, a forming die 102 is placed between a first structural member 106 and a second structural member 108 (e.g., during fit-up, or the like). A through hole 502 in the forming die 102 may be aligned with one or more through holes 702 of the structural members 106, 108 to receive a fastener 110, or the like.

FIG. 8B depicts a further embodiment of a system 810 for non-planar features 104 for a fastened connection. In the depicted embodiment, a forming die 102 is placed between a first structural member 106 and a second structural member 108 (e.g., during fit-up, or the like). A through hole 502 in the forming die 102 may be aligned with one or more through holes 702 of the structural members 106, 108 to receive a fastener 110, or the like.

The one or more non-planar features 104, in the depicted embodiment, alternate between extending up from the forming die 102 and extending down from the forming die 102, with negative space or other openings opposite the extensions, so that the non-planar features 104 of the forming die 102 deform material of the structural members 106, 108 with corresponding non-planar features 104 (e.g., the extensions of the non-planar features 104 being cold pressed into the material of the structural members 106, 108, material of the structural members 106, 108 being cold extruded into the negative space of the non-planar features 104, or the like).

FIG. 8C depicts a certain embodiment of a system 820 for non-planar features 104 for a fastened connection. In the depicted embodiment, a forming die 102 has been pressed and/or clamped between a first structural member 106 and a second structural member 108 to at least partially deform material of the structural members 106, 108 (e.g., forming corresponding non-planar features 104, cold pressing the extensions of the non-planar features 104 into the material of the structural members 106, 108, cold extruding material of the structural members 106, 108 into the negative space of the non-planar features 104, or the like). For example, tightening a fastener 110 disposed in the through holes 702, 502 may clamp and/or press the forming die 102 between the structural members 106, 108 as the fastener 110 is tightened, or an external press, clamp, or the like may be used.

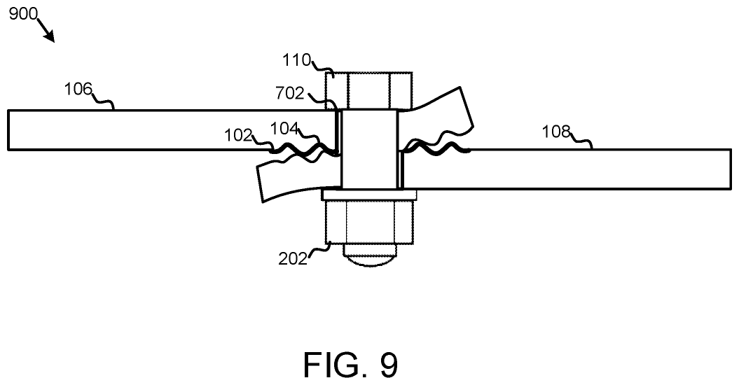

FIG. 9 depicts one embodiment of a system 900 for non-planar features 104 for a fastened connection. In the depicted embodiment, under load, the one or more non-planar features 104 have deflected at least a portion of the force of the load out of a plane of the structural members 106, 108, in a direction that is not orthogonal to the fastener 110. In some embodiments, by deflecting at least a portion of the force out of plane, the one or more non-planar features 104 may extend the life of the connection, delaying failure of the fastener 110, increase the load which the connection may bear, or the like. As described above, in certain embodiments, one or more washer-type elements 302, 304 may stiffen the connection and/or bear additional deflected load.

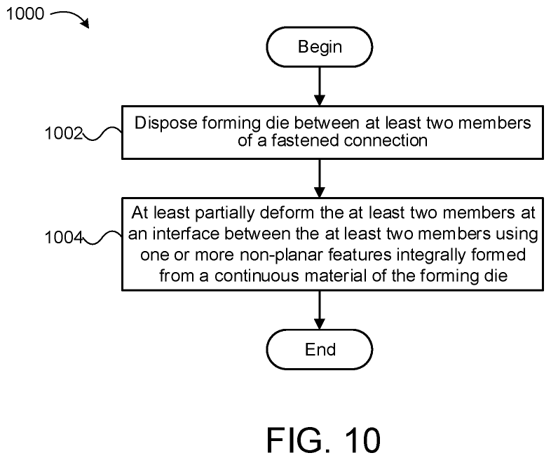

FIG. 10 depicts one embodiment of a method 1000 for non-planar features 104 for a fastened connection. In one embodiment, a user (e.g., an installer, a worker, or the like) may dispose 1002 a forming die 102 between at least two members 106, 108 of a fastened connection. A user, in a further embodiment, may at least partially deform 1004 the at least two members 106, 108 at an interface between the at least two members 106, 108 using one or more non-planar features 104 integrally formed from a continuous material of the forming die 102 (e.g., by tightening a fastener 110, using a press or clamp, or the like) and the method 1000 ends.

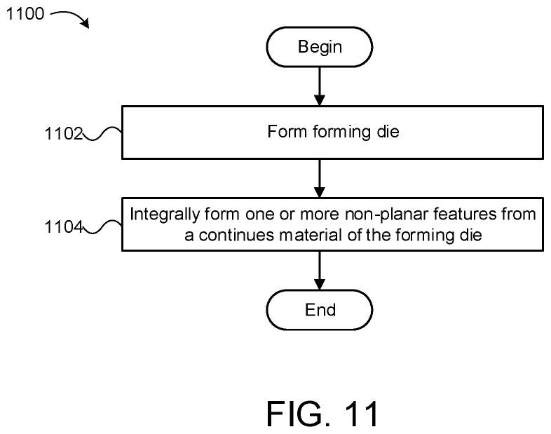

FIG. 11 depicts one embodiment of a method 1100 for non-planar features 104 for a fastened connection. A manufacturer (e.g., a worker, a manufacturing device, or the like), in certain embodiments, forms 1102 a forming die 102 (e.g., by stamping the forming die 102, die casting the forming die 102, injection molding the forming die 102, additive printing the forming die 102, or the like). A manufacturer, in a further embodiment, integrally forms 1104 one or more non-planar features 104 from a continuous material of the forming die 102 (e.g., by pressing the non-planar features 104 into the forming die 102, welding the non-planar features 104 onto the forming die 102, drilling the non-planar features 104 into the forming die 102, molding the non-planar features 104 as part of the forming die 102, or the like) and the method 1100 ends.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An apparatus comprising:
a forming die shaped to be disposed between at least two members of a fastened connection; and
one or more non-planar features integrally formed from a continuous material of the forming die to at least partially deform the at least two members at an interface between the at least two members.

2. The apparatus of claim 1, wherein the forming die is disposed at one or more through holes disposed through the at least two members, the one or more through holes are shaped to receive a fastener, and the forming die is shaped to at least partially deform the at least two members in response to a deformation load between the at least two members of the fastened connection due to an applied overload.

3. The apparatus of claim 2, wherein the forming die remains between the at least two members in response to at least partially deforming the at least two members as part of the fastened connection.

4. The apparatus of claim 2, wherein the forming die substantially maintains a shape in response to the deformation load.

5. The apparatus of claim 2, wherein the forming die comprises at least one through hole shaped to receive the fastener between the at least two members.

6. The apparatus of claim 2, wherein the forming die is disposed adjacent to the one or more through holes between the at least two members such that the fastener does not intersect the forming die.

7. The apparatus of claim 6, further comprising one or more additional through holes disposed through the at least two members shaped to receive one or more additional fasteners, the forming die disposed adjacent to and between the through holes and the one or more additional through holes such that the fastener and the one or more additional fasteners do not intersect the forming die.

8. The apparatus of claim 1, wherein the one or more non-planar features are shaped such that contact at the interface creates a resultant force that is not orthogonal to an axis of the fastener.

9. The apparatus of claim 1, wherein the one or more non-planar features transfer an external load from a first member of the at least two members to a second member of the at last two members at least partially through non-frictional mechanisms.

10. The apparatus of claim 1, wherein a height of the one or more non-planar features is selected to minimize separating deflections of the at least two members.

11. The apparatus of claim 1, further comprising one or more washer-type elements in a load path of the fastened connection, the one or more washer-type elements increasing a stiffness of the load path to minimize separating deflections.

12. The apparatus of claim 1, wherein a hardness of the forming die is greater than a hardness of the at least two members.

13. The apparatus of claim 12, wherein the forming die comprises one or more of a metallic and a ceramic material and the at least two members comprise a metallic material softer than the forming die.

14. The apparatus of claim 1, further comprising a waterproof seal disposed around the forming die between the at least two members.

15. The apparatus of claim 14, wherein the one or more non-planar features are shaped to form the waterproof seal.

16. A system comprising:
at least two members of a fastened connection;
through holes disposed through the at least two members, the through holes shaped to receive a fastener;
a forming die disposed between the at least two members of the fastened connection; and
one or more non-planar features integrally formed from a continuous material of the forming die to at least partially deform the at least two members at an interface between the at least two members.

17. The system of claim 16, wherein the forming die is disposed adjacent to the through holes between the at least two members such that the fastener does not intersect the forming die.

18. The system of claim 17, further comprising one or more additional through holes disposed through the at least two members shaped to receive one or more additional fasteners, the forming die disposed adjacent to and between the through holes and the one or more additional through holes.

19. The system of claim 16, wherein the one or more non-planar features are shaped such that contact at the interface creates a resultant force that is not orthogonal to an axis of the fastener.

20. A method comprising:
disposing a forming die between at least two members of a fastened connection; and
at least partially deforming the at least two members at an interface between the at least two members using one or more non-planar features integrally formed from a continuous material of the forming die.
